(19) United States
(12) Patent Application Publication
(10) Pub. No.: US 2018/0033016 A1
(43) Pub. Date: Feb. 1, 2018

(54) SYSTEMS AND METHODS FOR FACILITATING ACCESS TO PRODUCT INFORMATION

(71) Applicant: RacerX Inc., Canton, MA (US)

(72) Inventors: Avrum G. Mayman, Canton, MA (US); Todd W. Chapin, Cambridge, MA (US); Stephen K. Jungmann, Andover, MA (US); William A. Allen, Westborough, MA (US); Jaya Plmanabhan, Webster, NY (US)

(73) Assignee: RacerX Inc., Canton, MA (US)

(21) Appl. No.: 15/660,534

(22) Filed: Jul. 26, 2017

Related U.S. Application Data
(60) Provisional application No. 62/367,011, filed on Jul. 26, 2016.

(51) Int. Cl. G06Q 30/00; G06Q 10/00

(52) U.S. Cl. CPC G06Q 30/012; G06Q 30/016; G06Q 10/20

(57) ABSTRACT

Systems and methods for providing access to information related to a product. In some embodiments, in response to a first input from a user, at least one hardware sensor may be used to automatically scan a code associated with an item of the product. The data from the at least one hardware sensor may be analyzed to extract an identifier for the product, which may then be used to retrieve information relating to the product. The retrieved information may be displayed to the user.

### RELATED APPLICATION

This Application claims priority under 35 U.S.C. § 119(e) to U.S. Provisional Application Ser. No. 62/367,011, entitled “SYSTEMS AND METHODS FOR PRODUCT REGISTRATION,” filed on Jul. 26, 2016, which is herein incorporated by reference in its entirety.

### BACKGROUND

Many consumer products are shipped with materials printed on paper, such as user manuals, registration cards, catalogs of accessories, directories of service centers, etc. Consumers tend to throw these printed materials away, because there is no immediate need for the information contained in the printed materials. When a problem arises with a product, a consumer may search the Web for a user manual, customer support contact information, an address of a nearby service center, etc., and/or call a manufacturer to see if the product is still under warranty.

### SUMMARY

In some embodiments, a system is provided, comprising: at least one hardware sensor; at least one processor; and at least one computer-readable storage medium having encoded thereon instructions which, when executed by the at least one processor, program the at least one processor to: in response to a first input from a user, cause the at least one hardware sensor to scan a code associated with an item of the product; process data from the at least one hardware sensor to extract an identifier for the product; use the identifier for the product to retrieve information relating to the product; and display the retrieved information to the user.

The at least one computer-readable storage medium in the illustrative system described above.

A method performed by the illustrative system described above.

### BRIEF DESCRIPTION OF DRAWINGS

FIG. 1 shows an illustrative process 100 that may be performed by a curated product information system to introduce a consumer to a curated product information service, in accordance with some embodiments.

FIGS. 2A-H show illustrative screens 200A-H of the mobile device app of the curated product information system while performing the illustrative process 100 of FIG. 1, in accordance with some embodiments.

FIG. 3 shows an illustrative process 300 that may be performed by a curated product information system to receive from a consumer a notification of a subsequent item, in accordance with some embodiments.

FIGS. 4A-E show illustrative screens 400A-E of the mobile device app of the curated product information system while performing the illustrative process 300 of FIG. 3, in accordance with some embodiments.

FIG. 5 shows an illustrative data payload 500 as read by a general purpose code reader, in accordance with some embodiments.

FIG. 6 shows an illustrative process 600 that may be performed by a curated product information system to scan a label and extract product information, in accordance with some embodiments.

FIG. 7 shows an illustrative database 700 for storing personal information of consumers and an illustrative database 705 for storing product information, in accordance with some embodiments.

FIG. 8A shows an illustrative product database 805A and an illustrative mobile device 810A, in accordance with some embodiments.

FIG. 8B shows an illustrative product database 805B and an illustrative mobile device 810B, in accordance with some embodiments.

FIG. 8C shows an illustrative process 820 that may be performed by a mobile device app of a curated product information system to allow a consumer to indicate a product as being relevant, in accordance with some embodiments.

FIG. 9A shows an illustrative form 900A that may be presented by a web portal of a curated product information system to an employee of a manufacturer to prompt the employee to enter relevant information for a product, in accordance with some embodiments.

FIG. 9B shows an illustrative product detail page 900B that may be presented by a mobile device app of the curated product information system based on input provided by the employee of the manufacturer via the illustrative form 900A shown in FIG. 9A, in accordance with some embodiments.

FIG. 10A shows an illustrative form 1000A that may be presented by a web portal of a curated product information system to an employee of a manufacturer to prompt the employee to enter customization information, in accordance with some embodiments.

FIG. 10B shows an illustrative confirmation page 1000B that may be presented by a mobile device app of the curated product information system based on input provided by the employee of the manufacturer via the illustrative form 1000A shown in FIG. 10A, in accordance with some embodiments.

FIGS. 11A-C show illustrative consumer notification methods, in accordance with some embodiments.

FIG. 12 shows, schematically, an illustrative computer 1000 on which any aspect of the present disclosure may be implemented.

### DETAILED DESCRIPTION

The inventors have recognized and appreciated that shipping products with printed materials that many consumers simply throw away may be wasteful, and may contribute to environmental problems such as overflowing landfills, deforestation, etc. Also, such materials may become outdated (e.g., a manufacturer discontinuing an accessory) and thus of limited value to a consumer even if the consumer saves the materials.

Accordingly, in some embodiments, systems and methods are provided to help consumers access relevant and up-to-date product information, such as user manuals, catalogs of replacement parts, directories for service centers, customer support contact information, etc. Such access may be provided with fewer materials printed on paper, thereby reducing an environmental footprint. In some embodiments, product information may be delivered in via multimedia presentations (e.g., how-to videos) and/or in an interactive manner.

### I. Overview of Curated Product Information System

The inventors have recognized and appreciated various technical challenges in collecting, updating, and/or presenting product information in a manner that is convenient and relevant for individual consumers. For instance, the inventors have recognized and appreciated that product information on the Web has typically been organized based on manufacturer. As an example, to find a replacement part for a product, a consumer may visit a web site of a manufacturer of the product, and search for the product by entering a product category and/or a brief description. Alternatively, the consumer may use a general purpose search engine and enter a manufacturer name, a product category, and/or a brief description. Using either approach, it may take a non-trivial amount of time (and sometimes frustration) to find a vendor that sells the right part, because the consumer may not remember a precise name and/or model number for the product.

Accordingly, in some embodiments, an improved approach may be used to provide access to product information. Such an approach may be consumer centric, as opposed to manufacturer centric. For instance, a curated product information system may be provided that allows a consumer to easily access information relating to products that are indicated by the consumer as being relevant (e.g., items actually owned, possessed, and/or used by the consumer). Such a curated product information system may be accessed by the consumer in any suitable way, for example, via a web site and/or a mobile device app.

In some embodiments, a curated product information system may be programmed to exchange information between manufacturers and consumers. For instance, the curated product information system may receive from a consumer a notification regarding an item newly acquired by the consumer. Upon receiving such a notification, the curated product information system may store an indication that the particular product is relevant for the particular consumer, for instance, by linking a database entry corresponding to the consumer to a database entry corresponding to the product.

Additionally, or alternatively, a curated product information system may receive from a manufacturer information regarding a certain product and/or updates to such information. Upon receiving such information, the curated product information system may create and/or update a database entry corresponding to the product.

In some embodiments, a curated product information system may be programmed to display to a consumer a list of relevant products. The products may be organized in any suitable manner, for example, by manufacturer, product category, etc. Upon the consumer selecting a product from the list of products, the curated product information system may display to the consumer information relating to the selected product, such as serial number, date of purchase, vendor, registration date, warranty coverage and/or expiration, user manual, customer support contact information, catalog of replacement parts and/or accessories, directory of service centers, list of suppliers for consumables, manufacturer special offers, manufacturer privacy policy, link to manufacturer web site, link to video showing a repair method or a recommended method for using the product, etc.

Thus, in some embodiments, a curated product information system may allow a consumer to easily call up a single list of all items that the consumer has indicated as being relevant, and to access related product information from a single entry point in a user interface (UI) of the curated product information system. The inventors have recognized and appreciated that such a convenient interface may improve user experience, and may facilitate access to product-specific information even if an item is not Internet-enabled.

In some embodiments, a curated product information system may be programmed to provide consumer information to a manufacturer. For instance, the curated product information system may provide a list of consumers who have indicated that a certain product made by the manufacturer is relevant. Such a list may include any suitable information regarding each consumer, such as how many items of the product (e.g., tennis rackets that may differ only in date of purchase) are associated with the consumer. Additionally, or alternatively, the curated product information system may forward a message about the product from the manufacturer to such consumers. The inventors have recognized and appreciated that one or more of these functionalities may be used to deliver product safety information to consumers (e.g., during a safety recall).

The inventors have recognized and appreciated that a curated product information system may allow a consumer to easily submit the consumer's contact information to multiple manufacturers. For instance, a consumer may wish to be notified of all safety issues associated baby products purchased from different manufacturers. Instead of registering with each manufacturer separately, and hence having to create multiple accounts and/or go through different registration processes, the consumer may simply notify the person portal system each time a new item is acquired. As discussed in detail below, the curated product information system may provide a simple and consistent process for indicating that a newly acquired item is relevant, regardless of manufacturer, thereby reducing user friction. In some embodiments, the consumer's contact information may be pushed by the person portal system to appropriate manufacturers, and/or pulled by the manufacturer (e.g., via regularly scheduled consumer information downloads) from the curated product information system.

In some embodiments, a curated product information system may allow a consumer to easily update the consumer's contact information with multiple manufacturers (e.g., when the consumer moves). Instead of notifying each manufacturer separately, and hence having to go through multiple different update processes, the consumer may simply notify the person portal system of a change in contact information. In some embodiments, the consumer's new contact information may be pushed by the person portal system to all appropriate manufacturers, and/or pulled by the manufacturers (e.g., via regularly scheduled consumer information downloads) from the curated product information system.

In some embodiments, a curated product information system may allow a consumer to easily remove a product from the consumer's list of relevant products. Instead of notifying an appropriate manufacturer, which may or may not result in the consumer's contact information being removed from the manufacturer's mailing list, the consumer may simply notify the curated product information system that the consumer no longer considers the product to be relevant. In some embodiments, upon receiving such a notification, the curated product information system may stop forwarding messages from the manufacturer to the consumer, and may no longer allow the manufacturer to download the consumer's contact information. In this manner, the curated product information system may provide consumers with more control over their contact information, thereby reducing unwanted communications from manufacturers.

In some embodiments, a curated product information system may be integrated with a manufacturer's consumer relationship management (CRM) software. When a consumer updates personal data, delete a product from the consumer's list of relevant products, etc., the curated product information system may cause such a change to be reflected in the manufacturer's CRM software immediately.

The inventors have recognized and appreciated that a curated product information system may allow manufacturers to reach consumers in a more meaningful way. For instance, consumers may be accustomed to ignoring emails from manufacturers because there is too much spam, and may, as a result, miss important safety notifications. In some embodiments, a curated product information system may be programmed to alert a consumer of safety notifications in a distinctive manner (e.g., by displaying a red circle on a mobile device app icon), so that the consumer may easily distinguishable a safety notification from spam.

Furthermore, in some embodiments, a curated product information system may allow a manufacturer to specify links and/or other information presented to a consumer on a per-product basis. For instance, depending on consumers' needs, the manufacturer may for one product provide a link to re-order supplies, while for another product providing a link to a list service companies. Additionally, or alternatively, the curated product information system may allow the manufacturer to specify a look-and-feel of a product detail page presented to the consumer via the curated product information system.

In some embodiments, a curated product information system may allow a manufacturer to update (e.g., based on consumer feedback) product information made available to consumers via the curated product information system. When a consumer accesses a product detail page, the curated product information system may present to the consumer the most up-to-date product information indicated by the manufacturer (e.g., by refreshing from a database). In this manner, the consumer may stay informed without having to expend time or energy to search online for current information.

The inventors have further recognized and appreciated that a curated product information system may provide manufacturers with more visibility into who their consumers are and what information their consumers find relevant, which may facilitate consumer research, and lead to development of product features that are useful for consumers, and/or delivery of useful information to consumers. For instance, a manufacturer may maintain statistics regarding product information accessed by consumers (e.g., which links the consumers click and/or which pages the consumers ultimately navigate to), and may update the product information made available via the curated product information system to allow the consumers to reach relevant information more quickly (e.g., most popular how-to videos).

It should be appreciated that the techniques disclosed herein may be implemented in any of numerous ways, as the disclosed techniques are not limited to any particular manner of implementation. Examples of details of implementation are provided solely for illustrative purposes. Furthermore, the disclosed techniques may be used individually or in any suitable combination, as aspects of the present disclosure are not limited to the use of any particular technique or combination of techniques.

### II. Product Registration via Curated Product Information System

The inventors have recognized and appreciated that, for many years, consumer product manufacturers have included a product registration card with their products. The purpose of these cards is for consumers to provide contact information, such as their names and addresses, for two primary reasons.
To establish ownership for warranty purposes.
To facilitate post-sale communications, such as when a safety issue arises.

With the emergence of the Internet, some manufacturers have replaced product registration cards with online forms. A consumer may access an online product registration form by either searching through a manufacturer's website, or by entering an often complex URL. Once on the page, the consumer may be prompted to enter their personal information, as well as a product model number and/or a serial number (if serialized). Often, a consumer's computer and an item to be registered may not be in the same location, so some mechanism for copying the product information is required. Such information (e.g., product model number and/or serial number) may be lengthy, and it may be cumbersome for a consumer to copy accurately. Alternatively, the consumer may bring a mobile device to the item, and type the information into the mobile device, which may also be challenging because a virtual keyboard on the mobile device may be small and the consumer may easily make typographical errors.

Furthermore, a consumer may have to go through a separate process (e.g., separate web forms) for every manufacturer, even though the same contact information is entered each time (e.g., full name, email address, phone number, street address, etc.). When the contact information changes (e.g., when the consumer moves), each manufacturer may have to be separately notified. Also, a manufacturer may not provide an easy way for a consumer to notify the manufacturer when the consumer no longer finds a product to be relevant. As a result, the consumer may continue to receive unwanted communications from the manufacturer.

Furthermore, some manufacturers may ask consumers to create new accounts, and different manufacturers may have different requirements for user name and/or password, so a consumer may end up with numerous user name and password combinations that the consumer cannot realistically remember.

Furthermore, manufacturers may not provide consumers with a convenient record of registered products, nor easy access to relevant information, such as serial number, date of purchase, vendor, registration date, warranty coverage and/or expiration, user manual, customer support contact information, catalog of replacement parts and/or accessories, directory for service centers, list of suppliers for consumables, manufacturer special offers, manufacturer privacy policy, link to manufacturer web site, link to video showing a repair method or a recommended method for using the product, etc. The inventors have recognized and appreciated that some approaches may address some of these above-described deficiencies. One approach may employ a code (e.g., a QR code) and a code reader to direct a consumer's mobile device to a registration web page, where a product model number and/or a serial number have been pre-populated based on information embedded in the code. This approach may save the consumer the hassle of copying product information. However, the consumer may still be asked to enter personal information. This may be cumbersome, especially if the mobile device has only a virtual keyboard, which many consumers find challenging to use. Furthermore, a consumer may have to find, download, and install a suitable code reader, which may create user friction and cause the consumer to abandon the process.

Another approach may include instructing a consumer to take a picture of a proprietary label and to text or otherwise send that image to a specified address such as a phone number or an email address. A URL may then be returned that the consumer may tap, which may take the consumer to a manufacturer-branded web page with a product model number and/or a serial number pre-populated. The remainder of the process may be the same as in the code reader approach described above. One advantage of the proprietary label approach may be that the consumer may not need to find a suitable code reader. However, a manufacturer may have to invest in software to create the proprietary label, which may make it more challenging to ensure that the product is labeled correctly.

Thus, while the consumer may no longer need to find the right registration web page or enter product information, the consumer may still need to enter personal information repeatedly at different manufacturers' web sites using different registration workflows, notify different manufacturers separately when contact information changes, etc., as discussed above. These approaches may even create new challenges, such as data entry errors (e.g., typo due to difficulty in using a virtual keyboard, incorrect autofill, entering data in a wrong field, etc.) and/or finding a suitable code reader.

The inventors have recognized and appreciated that, in some embodiments, a curated product information system may be used advantageously to allow a consumer to register an item with an appropriate manufacturer with little effort on the part of the consumer. For instance, in some embodiments, a label in a standardized format (e.g., QR code and/or bar code) may be provided on an item, its packaging, or other associated material (e.g., a pamphlet or card inside the packaging). Since a standardized format is used, the label may be created without proprietary software.

In some embodiments, a mobile device app of the curated product information system may be used to automatically read the label and extract product information (e.g., a product model number and/or a serial number). The mobile device app may present information about a product specified by the extracted product information to prompt the consumer to confirm that the extracted product information matches the item the consumer is attempting to register. For instance, the mobile device app may display a user-friendly product name and/or a product photo to prompt the consumer for confirmation. The curated product information system may be programmed to, upon receiving the consumer's confirmation, bundle the product information with the consumer's personal information (e.g., retrieved from the consumer's mobile device, or from the consumer's account with the curated product information system), and to make the bundled information available to the manufacturer. In this manner, registration may be completed as simply as snapping a picture, without being directed to a web page or typing anything on a virtual keyboard.

In some embodiments, in response to a request from a consumer to register an item of a product, a curated product information system may be programmed to check if the consumer has previous registered another item of the same product (e.g., by looking up a list of items previously registered by the consumer). If such an item is found, the curated product information system may prompt (e.g., via a mobile device app of the curated product information system) the consumer to confirm whether the consumer wishes to register a new item of the same product. Upon receiving confirmation from the consumer, the curated product information system consumer may create a new product entry having one or more attributes that are different from an existing product entry (e.g., different purchase date, color, serial number, etc.)

It should be appreciated that aspects of the present disclosure are not limited to the use of a mobile device app. In some embodiments, a consumer may be instructed to text, email, or otherwise send a picture of a label to a specified number, email address, or other address, respectively, associated with a curated product information system, which may then extract product information from the picture and bundle the product information with the consumer's personal information retrieved from the consumer's account with the curated product information system.

### III. Improved User Experience

A. Account Creation

The inventors have recognized and appreciated that often a provider asks a consumer to create a new account before the consumer has had to chance to experience the provider's service and determine whether the service is actually useful. As a result, some consumers decide not to sign up for a service that would have turned out to be beneficial (e.g., a service that timely notifies consumers of product safety issues). Accordingly, in some embodiments, techniques are provided to allow a consumer to experience a curated product information service without creating an account.

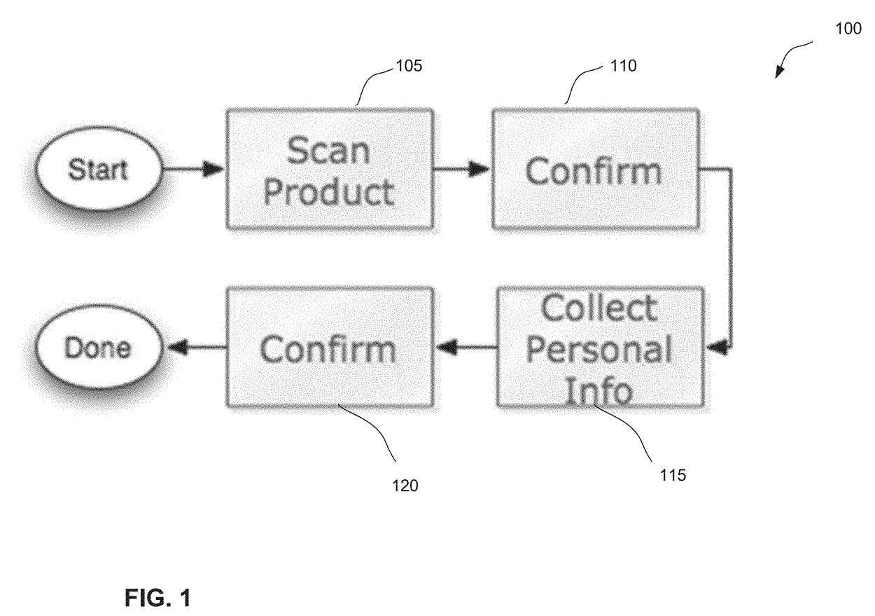

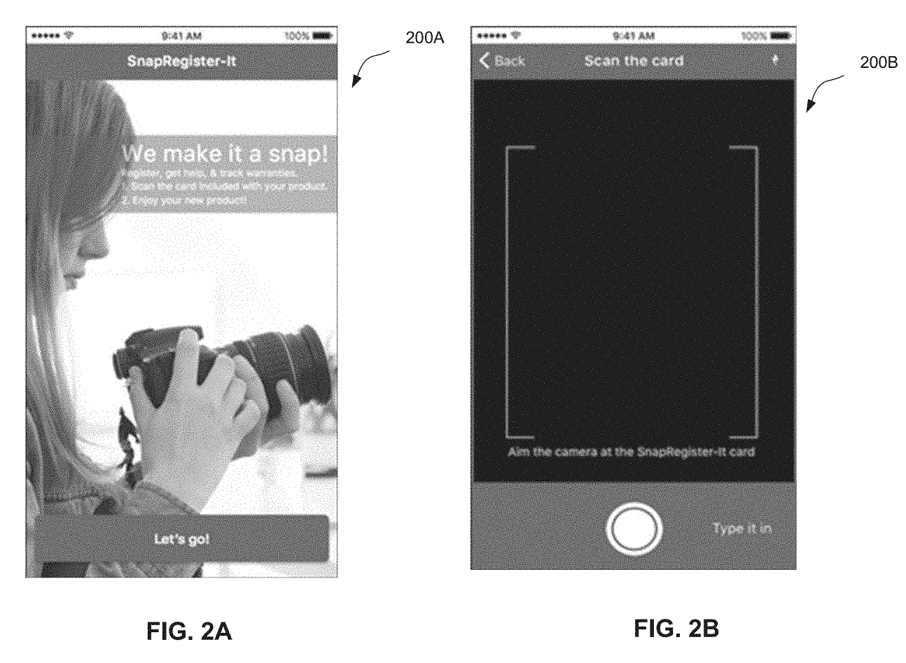

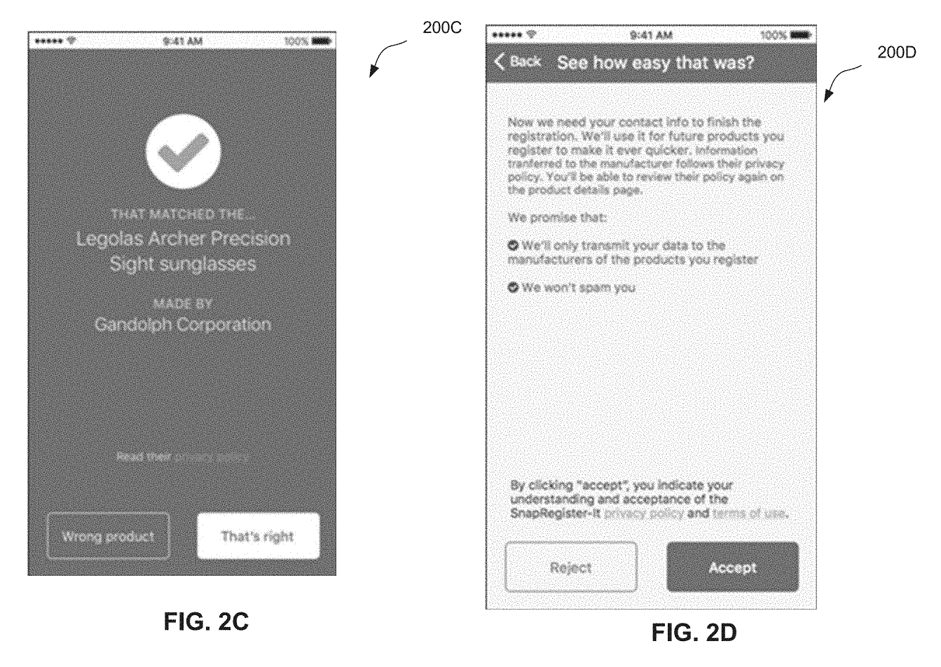

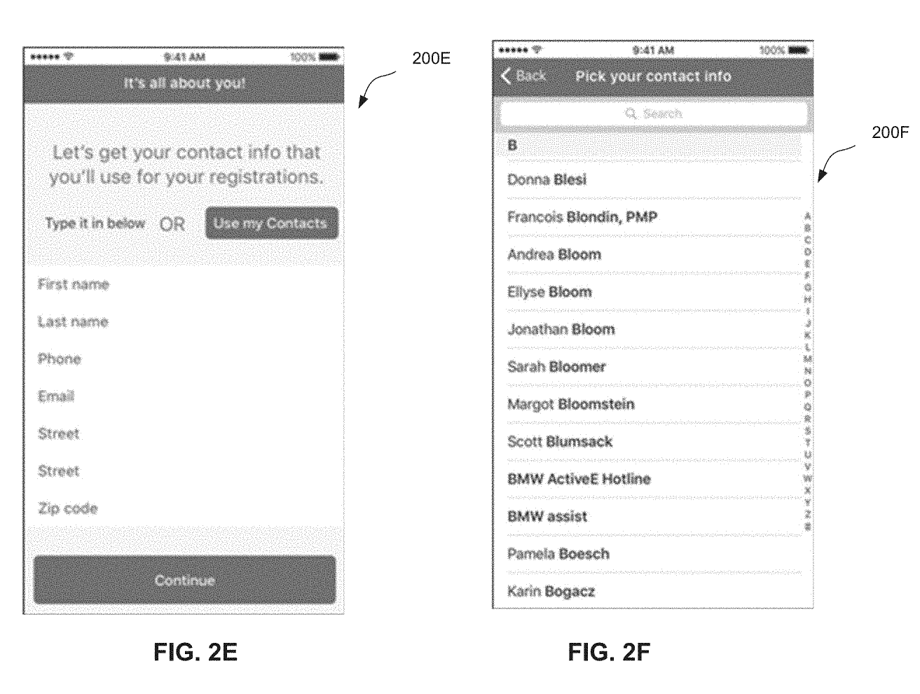

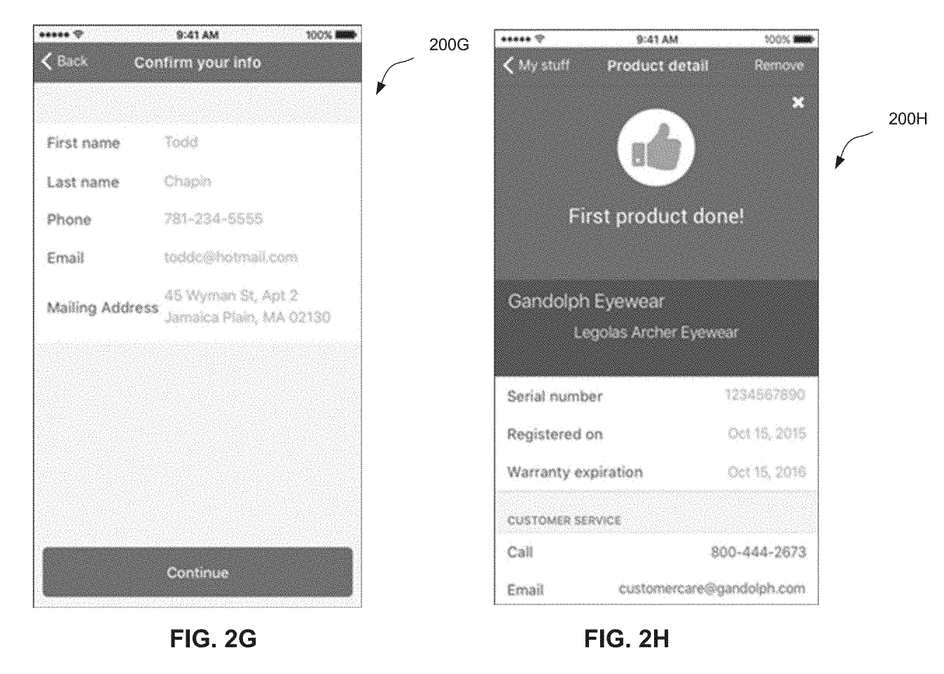

FIG. 1 shows an illustrative process 100 that may be performed by a curated product information system to introduce a consumer to a curated product information service, in accordance with some embodiments. In this example, the consumer may be informed of the curated product information service upon purchasing a new item. For instance, a label in a standardized format (e.g., QR code and/or bar code) may be provided on the item, its packaging, or other associated material (e.g., a pamphlet or card inside the packaging), along with an instruction to download and install a mobile device app of the curated product information system. The mobile device app may be programmed to demonstrate to the consumer how easy it is to get relevant information about the newly purchased item, before asking the consumer to sign up for the service. FIGS. 2A-H show illustrative screens 200A-H of the mobile device app of the curated product information system while performing the illustrative process 100 of FIG. 1, in accordance with some embodiments.

At act 105, the mobile device app may prompt the consumer to scan the label provided with the item. In the example shown in FIG. 2A, the consumer has downloaded and launched the mobile device app. In the example shown in FIG. 2B, the mobile device app prompts the consumer to aim a camera of the consumer's mobile device at the label. The mobile device app may be programmed to automatically detect and capture the label when the camera is sufficiently aligned with the label. Once an image is captured, the mobile device app may automatically analyze the image to extract encoded information, such as product identification information (e.g., a product model number and/or a serial number).

In some embodiments, the label may be permanently affixed to the item (e.g., printed onto a housing of the item). In some embodiments, the label may be affixed to the item in an easily removed manner (e.g., using a peelable adhesive). In some embodiments, the label may be provided on packaging or other associated material (e.g., a pamphlet or card inside the packaging). In some embodiments, the label may be displayed by the item itself (e.g., where the item is an electronic device with a visual display).

At act 110, the curated product information system may automatically match the extracted information to a known product. For instance, the curated product information system may use the extracted information to look up a database of supported products. In some embodiments, such a database may be stored on the consumer's mobile device, and may be updated when the mobile device app of the personal portable system is launched while the mobile device is connected to the Internet. Additionally, or alternatively, a product database may be stored in the cloud, and the mobile device app may be programmed to query the product database via an Internet connection. This may reduce an amount of local storage used by the mobile device app, but may prevent the mobile device app from performing the matching when the mobile device is not connected to the Internet.

In response to identifying a match in the product database, the mobile device app may prompt the consumer to confirm the identified product is correct. For instance, as shown in FIG. 2C, the mobile device app may display a product name and/or a manufacturer name, and may prompt the consumer to indicate whether the displayed product information matches the item acquired by the consumer.

In some embodiments, the mobile device app may present to the consumer additional information that is available for the identified product, such as links to user manuals, catalogs of replacement parts, directories for service centers, customer support contact information, etc. In the manner, the consumer may gain a better understanding of the mobile device app's functionalities, and may be able to make a more informed decision about whether to use the curated product information service.

In the example shown in FIG. 2D, the mobile device app presents a message explaining how personal information collected from the consumer may be used. Additionally, or alternatively, links to a privacy policy and/or terms of use may be presented. If the consumer decides not to use the curated product information service, the consumer may exit and/or delete the mobile device app.

At act 115, the curated product information system may, after the consumer indicates a desire to use the curated product information service (e.g., by accepting the privacy policy and terms of use), proceed to collect personal information from the consumer. In the example shown in FIG. 2E, the mobile device app prompts the consumer to type in the personal information, or to allow the mobile device app to retrieve the personal information from the mobile device's storage (e.g., the consumer's address book). In the example shown in FIG. 2F, the consumer allows the mobile device app to access the consumer's address book, and the mobile device app prompts the consumer to select an entry (e.g., the consumer's own name) from the address book.

At act 120, the mobile device app may prompt the consumer to confirm the personal information provided by the consumer. In the example shown in FIG. 2G, the mobile device app displays the personal information, and prompts the consumer for confirmation. In the example shown in FIG. 2H, the mobile device app, upon receiving the consumer's confirmation, presents a product detail page for the matched product. The product detail page may display any suitable information about the product, including, but not limited to, serial number, date of purchase, vendor, date of registration, warranty coverage and/or expiration, user manual, customer support contact information, catalog of replacement parts and/or accessories, directory for service centers, list of suppliers for consumables, manufacturer special offers, manufacturer privacy policy, link to manufacturer web site, and link to video showing a repair method or a recommended method for using the product.

In some embodiments, a consumer may use a curated product information system from several mobile devices. The curated product information system may be programmed to synchronize data stored on the disparate devices. For instance, if the consumer updates one or more pieces of personal information (e.g., mobile phone number or street address) from a first device, the curated product information system may be programmed to perform a corresponding update on a second device when the consumer accesses the curated product information system using the second device.

In some embodiments, a mobile device app of a curated product information system may be programmed to monitor for changes in information in an address book on a consumer's mobile device, and may automatically update personal details of the consumer in the curated product information system accordingly. Additionally, or alternatively, the curated product information system may cause the changes in the address book to be reflected in a manufacturer's customer relationship management (CRM) software record (e.g., if the consumer has indicated one of the manufacturer's products as being relevant).

B. Listing Subsequent Items with Curated Product Information System

The inventors have recognized and appreciated that it may be beneficial to provide a frictionless method for use by a consumer to notify a curated product information system of a newly acquired item. For instance, ease of use may encourage more consumers to list items with the curated product information system, which may facilitate timely dissemination of important information such as safety recalls.

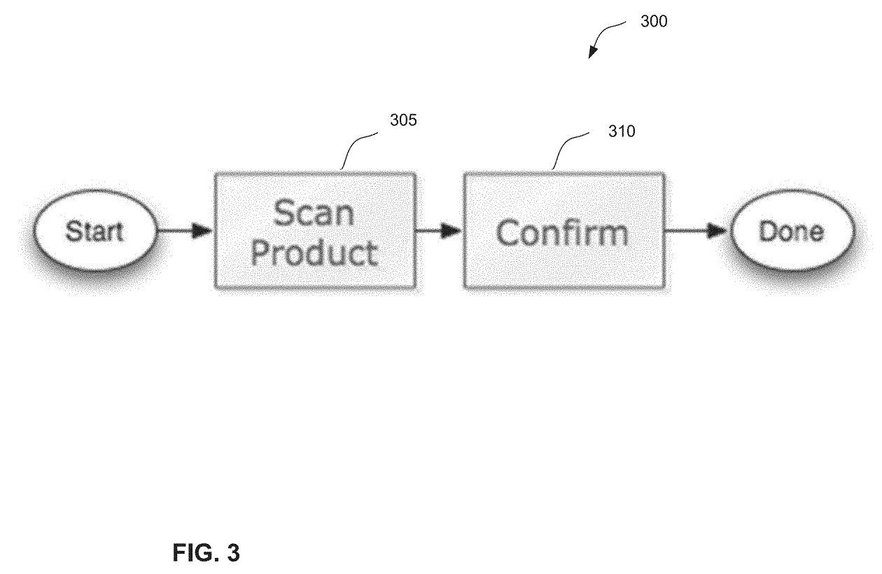

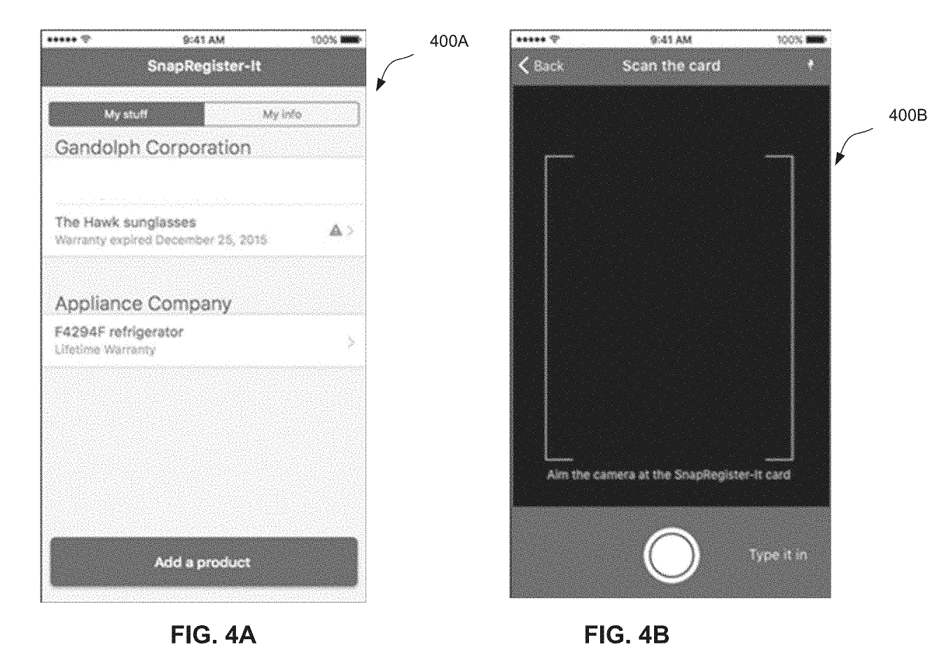

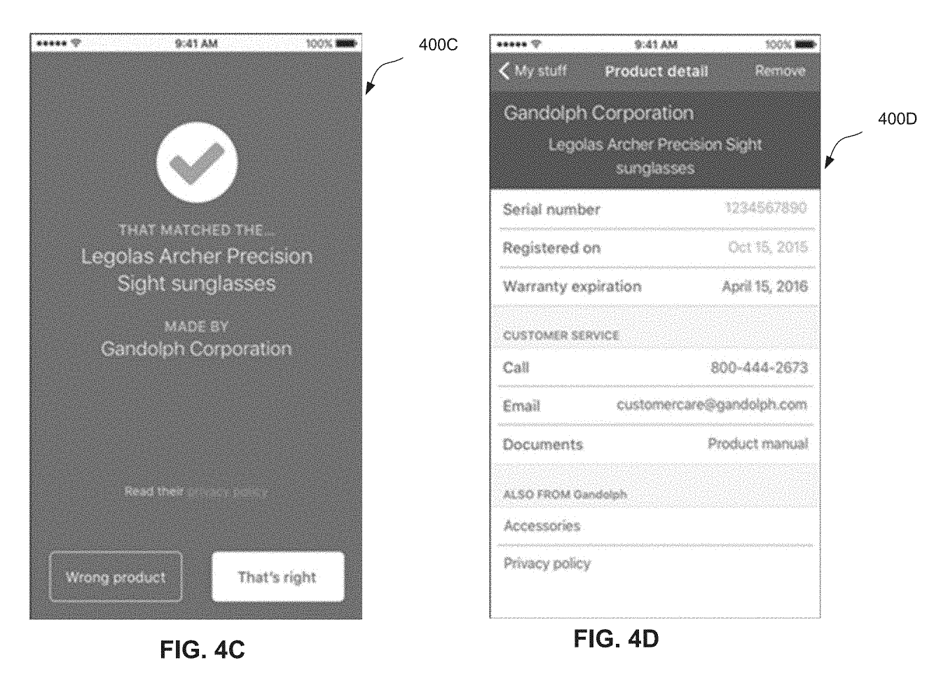

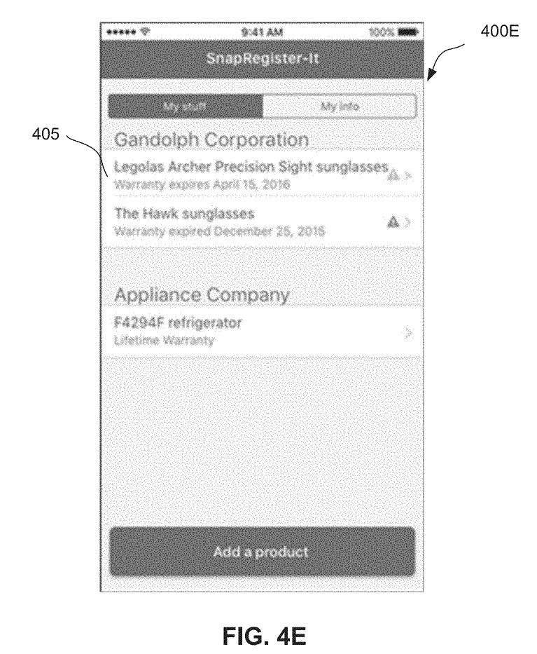

Accordingly, in some embodiments, techniques are provided for allowing a consumer to notify a curated product information system of a subsequent item using no more than two taps on the consumer's mobile device, after the consumer has previously notified the curated product information system of at least one item. FIG. 3 shows an illustrative process 300 that may be performed by a curated product information system to receive from a consumer a notification of a subsequent item, in accordance with some embodiments. FIGS. 4A-E show illustrative screens 400A-E of the mobile device app of the curated product information system while performing the illustrative process 300 of FIG. 3, in accordance with some embodiments.

At act 305, the mobile device app may prompt the consumer to scan the label provided with the subsequent item. In the example shown in FIG. 4A, the mobile device app presents to the consumer a list of one or more items previously indicated by the consumer as being relevant, as well as an “Add a product” button. In the example shown in FIG. 4B, after activating the “Add a product” button (which may be a first tap), the consumer is instructed to aim a camera of the consumer's mobile device at the label. The mobile device app may be programmed to automatically detect and capture the label when the camera is sufficiently aligned with the label. Once an image is captured, the mobile device app may automatically analyze the image to extract encoded information, such as product identification information (e.g., a product model number and/or a serial number).

At act 310, the curated product information system may automatically match the extracted information to a known product, for instance, as described above in connection with act 110 of FIG. 1. In response to identifying a match, the mobile device app may prompt the consumer to confirm the identified product is correct. In the example shown in FIG. 4C, the mobile device app displays a product name and/or a manufacturer name, and prompts the consumer to indicate whether the displayed product information matches the item acquired by the consumer. In the example shown in FIG. 4D, the mobile device app, upon receiving the consumer's confirmation (which may involve a second tap), presents a product detail page for the matched product. The product detail page may display any suitable information about the product, including, but not limited to, serial number, date of purchase, vendor, registration date, warranty coverage and/or expiration, user manual, customer support contact information, catalog of replacement parts and/or accessories, directory for service centers, list of suppliers for consumables, manufacturer special offers, manufacturer privacy policy, link to manufacturer web site, and link to video showing a repair method or a recommended method for using the product.

In the example shown in FIG. 4E, the consumer returns to the list of relevant items, and the curated product information system is programmed to automatically update the list to include the newly acquired item, as shown at 405. From this list, the consumer may be able to access a product detail page for each product by simply tapping on the product name.

The inventors have recognized and appreciated that existing registration methods offer no record of items that have been registered, and no product information associated with registered items, such as warranty information, owner's guides, customer support contact information, etc. As a result, a consumer must expend significant effort to gather and maintain such information in an easily accessed form. By contrast, registration via a curated product information system, in accordance with some embodiments, may provide simple access to information about all of the products that a consumer has registered (e.g., the illustrative screen 400E shown in FIG. 4E), along with additional information for each of the product as provided by a corresponding manufacturer (e.g., the illustrative screen 400D shown in FIG. 4D). In some embodiments, this information may be accessible via a mobile device app installed on a consumer's mobile device. Additionally, or alternatively, this information may be accessible via a web site of the curated product information system.

The inventors have recognized and appreciated that), unlike information that is printed on paper and shipped with products, relevant product information made available via a curated product information system may be kept up-to-date (e.g., based on information submitted by manufacturers).

It should be appreciated that aspects of the present disclosure are not limited to the display of any particular information regarding a product. For instance, in some embodiments, a manufacturer may provide information to help a consumer enjoy a newly purchased item (e.g., recipes for a cooking appliance) in addition to, or instead of, the information described above.

C. Listing Items without Creating Account

The inventors have recognized and appreciated that some consumers may, for security reasons, be reluctant to share Personally Identifiable Information (PII). Accordingly, in some embodiments, no PII is transmitted from a consumer's device to a curated product information system's server. For instance, in some embodiments, a customer identifier may be generated (e.g., randomly) and transmitted to the server. The server may associate this identifier with products indicated by the consumer as being relevant. In this manner, a manufacturer may communicate with the consumer via the curated product information system, without ever knowing the consumer's name, email address, phone number, etc. The inventors have further recognized and appreciated that it may be cumbersome for a consumer to remember yet another username and password combination. Accordingly, in some embodiments, a consumer may be able to list items without setting up a username and password combination.

In some embodiments, a mobile device app of a curated product information system may be programmed to generate a token based on a consumer's email address and phone number. The mobile device app may be running on the consumer's mobile device and may have access to the consumer's email address and phone number via the mobile device's operating system. Instead of transmitting PII to the curated product information system's server, the token may be transmitted and used to identify the consumer. In such an embodiment, the consumer may be able to access the curated product information system by simply bringing the mobile device app to a foreground. The inventors have recognized and appreciated that it may be desirable to generate a token based on email address and phone number, because those two pieces of information are likely to remain the same even if a consumer switches to a new device, or uses different devices at different times. Furthermore, if a consumer deletes and later reinstalls the mobile device app, the same token may be generated and used to recover a list of items previously indicated by the consumer as being relevant, as long as the consumer has the same email address and phone number.

However, it should be appreciated that aspects of the present disclosure are not limited to the use of email address and phone number to generate a token, as a token may be generated using any one or more pieces of suitable information, such as name, account identifier, email address, phone number, street address, device identifier, network address, etc.

In some embodiments, a token generated by a mobile device app of a curated product information system may be uniquely linked to a consumer's mobile device. The mobile device app may transmit the token to a server of the curated product information system (e.g., to be associated with an entry for the consumer in a consumer database). In this manner, when the consumer opens the mobile device app on the same device in the future, the token may be used to access the consumer's account information from the server.

Furthermore, in some embodiments, a consumer may be given an option to set up a password to unlock a mobile device app of a curated product information system when the mobile device app is brought to the foreground or awakened from sleep mode. Additionally, or alternatively, a fingerprint scan or other biometric security mechanism may be used to unlock the mobile device app.

### IV. Label Generation

In some embodiments, a curated product information system is programmed to combine personal information of a consumer with product information of a product indicated by the consumer as being relevant. The inventors have recognized and appreciated that some manufacturers use certain codes, such as Universal Product Codes (UPCs) and International Article Numbers (EANs), to uniquely identify product models. Thus, such a code may be used to infer model name and/or manufacturer name unambiguously. The inventors have further recognized and appreciated that some manufacturers use serial numbers to uniquely identify individual units of a particular model of product. Thus, a product code (e.g., UPC or EAN) and/or a serial number may be used to identify an item acquired by a consumer. Accordingly, in some embodiments, such information may be encoded in a label that is provided with the item.

In some embodiments, a standard format (e.g., QR code or bar code) may be used to represent product information (e.g., UPC, EAN, and/or some other product model identifier) as a pattern, and the pattern may be provided on a label affixed to an item. Such a pattern may be referred to herein as a scannable code. A mobile device app of a curated product information system may include a reader configured to capture and analyze the pattern, and extract a data payload, which may include the product information, information regarding the curated product information system, etc.

In some embodiments, a pattern may be an optical pattern, and a mobile device app of a curated product information system may include a camera for capturing an image of the pattern, as well as software for analyzing the image. However, that is not required, as in some embodiments, one or more other detection techniques (e.g., radio frequency, magnetic and/or capacitive sensing) may be used in addition to, or instead of, optical detection. For instance, in some embodiments, a radio frequency identification (RFID) tag may be attached to an item of a product, and a curated product information system may include an RFID reader.

In some embodiments, a data payload of a scannable code associated with a curated product information system may include a selected logical flag. A mobile device app of the curated product information system may be programmed to ingest a scannable code only if the selected logical flag is found. If the selected logical flag is not found in the scannable code, the mobile device app may present an error message, and/or instructions to find a scannable code that is recognizable by the curated product information system, for example, to avoid confusion on the part of a consumer if the consumer attempts to scan a code that is not compatible with the curated product information system.

In some embodiments, a data payload of a scannable code may include a digital signature for verifying authenticity of an item.

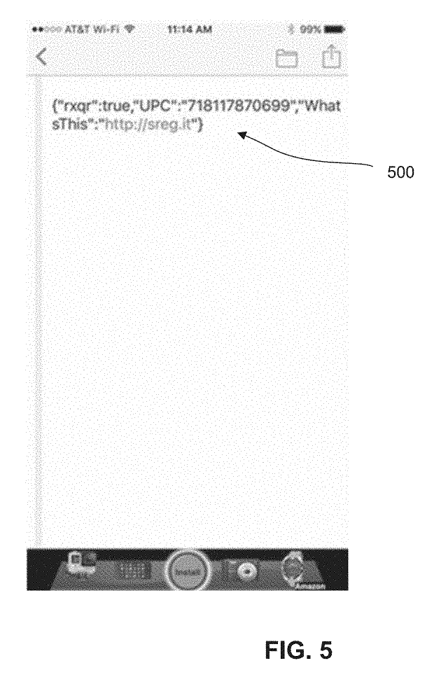

In some embodiments, a data payload of a scannable code may include one or more pieces of information that is readable by a general purpose code reader. For example, the payload may include a URL associated with a curated product information system. Upon scanning the code, a general purpose code reader may present this URL to the consumer, so that the consumer may follow the URL to learn more about the curated product information system, and/or to download a mobile device app of the curated product information system. FIG. 5 shows an illustrative data payload 500 as read by a general purpose code reader, in accordance with some embodiments.

In some embodiments, a data payload of a scannable code may include logistics information, such as information indicating how and/or to which destination an item was shipped (e.g., retailer name and address, warehouse name and address, purchase order number, lot number, manufacturing line identifier, etc.). This may facilitate tracking and prevent goods from being distributed through unauthorized channels. Additionally, or alternatively, logistics information may be used to verify authenticity of an item.

The inventors have recognized and appreciated it may be desirable to format a data payload of a scannable code in such a way as to facilitate parsing, identifying, and/or extracting of multiple data elements. Furthermore, it may be desirable to format a data payload of a scannable code to facilitate human inspection and/or simplify coding of software that would process the data payload. Accordingly, in some embodiments, a data payload of a scannable code may include elements constructed in a standardized format, such as a JavaScript Object Notation (JSON) open-standard format. Below is an illustrative data payload constructed in a JSON format, including a logical flag (“rxqr”:true), a UPC (“UPC”:“123456789012”), a serial number (“SN”:“001”), and a URL (“WhatsThis”:“http://sreg.it”).

{“rxqr”:true, “UPC”:“123456789012”, “SN”:“001”, “WhatsThis”:“http://sreg.it”}

While the inventors have recognized and appreciated various advantages of using a standard format to construct a data payload, it should be appreciated that aspects of the present disclosure are not limited to the use of any particular standard format, or any standard format at all. In some embodiments, a proprietary format and/or obfuscation may be used, so that a scannable code is readably only by a mobile device app of a curated product information system.

### V. Scanning Label and Extracting Product Information

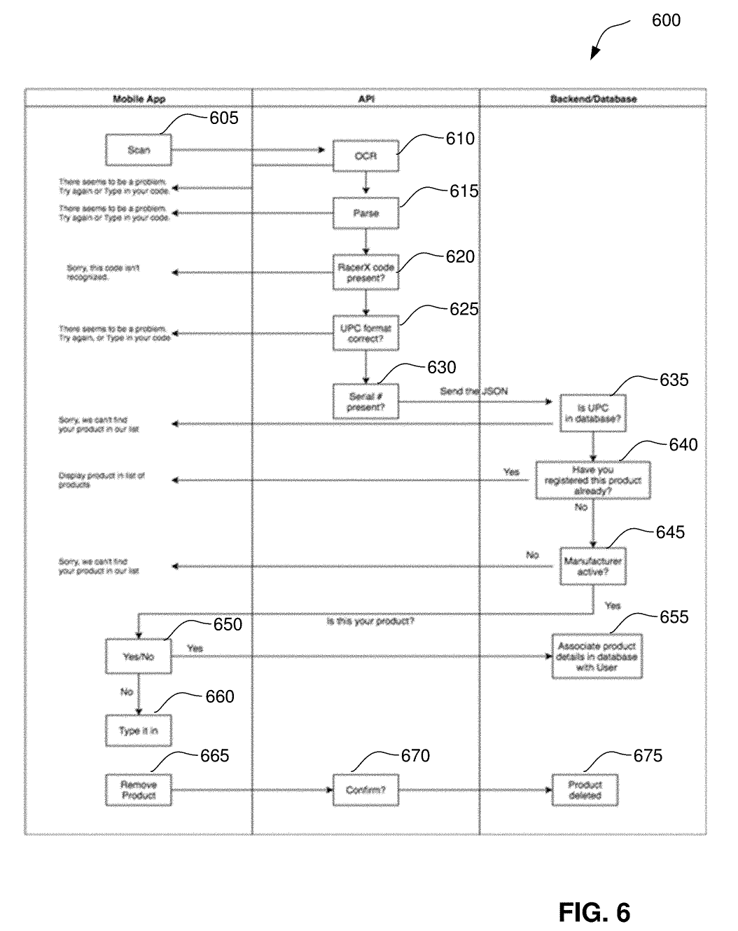

FIG. 6 shows an illustrative process 600 that may be performed by a curated product information system to scan a label and extract product information, in accordance with some embodiments. For instance, the illustrative process 600 may be performed in connection with the illustrative screens 400C-D shown respectively in FIGS. 4C-D.

At act 605, a consumer may launch a mobile device app of the curated product information system and navigate to a scanning page (e.g., the illustrative screen 400C shown in FIG. 4C). Upon the consumer arriving at the scanning page, the mobile device app may automatically activate a camera of the consumer's mobile device, and put the camera in a standby mode. The mobile device app may be programmed to detect when a scannable code is aligned with an on-screen frame, and in response cause the camera to capture an image of the scannable code.

At act 610, the mobile device app may proceed to analyze the captured image and output textual data. In some embodiments, the label may include an alphanumerical code, and one or more optical character recognition techniques may be used to convert an image of the alphanumerical code into textual data. Additionally, or alternatively, the label may include a scannable code according to a suitable format (e.g., QR code), and corresponding software may be used to convert an image of the scannable code into textual data. At act 615, the mobile device app may parse the textual data to identify one or more data components.

In some embodiments, if the mobile device app is unable to recognize textual data, or unable to parse recognized textual data, the mobile device app may present an error message to the consumer, which may prompt the consumer to try again or type in a code (e.g., a human-readable code provided in addition to a scannable code) that identifies a product. For instance, the scannable code may be improperly printed (e.g., blurry, incomplete, etc.), damaged, or otherwise deficient, and such deficiency may prevent a successful scan from taking place. After trying to scan for a selected period of time, a time-out may occur, and the mobile device app may present the following error message to the consumer.

“There seems to be a problem. Try again or type in your code.”

At act 610, the mobile device app may check if a logical flag associated with the curated product information system is present. In some embodiments, if an appropriate logical flag is not present, the mobile device app may present an error message to the consumer, indicating the scanned code is not recognized. For instance, the mobile device app may present the following error message to the consumer.

“Please scan a valid code.”

If an appropriate logical flag is present, the mobile device app may proceed to act 625 to check if a product code in a data payload of the scannable code has an expected format (e.g., valid UPCs and EANs may be 12 and 13 digits long, respectively). If the mobile device app recovers a product code that is not of an expected format (e.g., not 12 or 13 digits long), the mobile device app may present an error message to the consumer, which may prompt the consumer to try again or type in a code (e.g., a human-readable code provided in addition to a scannable code) that identifies a product. For instance, the mobile device app may present the following error message to the consumer.

“There seems to be a problem. Try again or type in your code.”

If the recovered product code is of an expected format, the mobile device app may proceed to act 630 to check if a serial number is present, and send one or more data elements extracted from the image of the scannable code to a backend of the curated product information system.

In some embodiments, one or more of acts 605 through 630 may be used by a manufacturer to confirm that a label is created properly and that accurate product information can be recovered by scanning the label and processing the resulting image.

In some embodiments, the backend may reside on the consumer's mobile device and/or a server of the curated product information system, and may have access to one or more databases. For instance, at act 635, the backend may check whether a product code extracted from the image of the scannable code is in a database of supported products. If not, the mobile device app may present an error message to the consumer, indicating the product identified by the consumer is not in a list of products supported by the curated product information system. For instance, the mobile device app may present the following error message to the consumer.

“Sorry, we can't find your product in our list.”

If there is a match in the product database, the backend may proceed to act 640 and check if the consumer has already indicated the product identified by the product code as being relevant. For instance, the backend may access a list of products previous indicated by the consumer as being relevant, and determine if the product identified by the product code is already in the list. If so, the mobile device app may present a message to the consumer explaining the same (e.g., by displaying the list of products indicated by the consumer as being relevant, and highlighting the product identified by the product code and/or a date on which the consumer indicated the product as being relevant).

In some embodiments, serial numbers may be used to determine if the consumer previously submitted information for at least one item of the product and is submitting information for another item of the same product. Additionally, or alternatively, the mobile device app may present the following message to prompt the consumer for clarification.

“You've already registered one of those. Do you own more than one?”

At act 645, the backend may check whether a manufacturer associated with the product code is active. For instance, if a manufacturer is no longer participating, the curated product information system may deactivate product codes associated with the manufacturer. If the manufacturer is no longer active, the mobile device app may present an error message to the consumer, indicating the product is not in a list of products supported by the curated product information system. For instance, the mobile device app may present the following error message to the consumer.

“Sorry, we can't find your product in our list.”

If the manufacturer is no longer active, the mobile device app may prompt the consumer to confirm if the product identified by the product code matches the item the consumer wishes to indicate as being relevant.

In some embodiments, acts 605 through 645 may take place without any intervention by the consumer. The consumer may only aim the camera at the label. Alternatively, or additionally, the consumer may be directed to take a picture of the label and text the picture to a selected number associated with the curated product information system. A server of the curated product information system may analyze the picture and extract product information.

If the mobile device app receives a positive indication from the consumer at act 650, the backend may, at act 655, store an indication that the consumer is associated with the product identified by the product code. For instance, an entry corresponding to the consumer in a consumer database may be updated to include a tag to the product identified by the product code. As a result, the product may appear in the consumer's list of relevant products in the curated product information system If the mobile device app receives a negative indication from the consumer at act 650, the mobile device app may, at act 660, present an error message to the consumer, which may prompt the consumer to type in a code (e.g., a human-readable code provided in addition to a scannable code) that identifies a product.

In some embodiments, the curated product information system may allow the consumer to easily remove a product from the consumer's list of relevant products. For instance, in the example shown in FIG. 6, the mobile device app may receive, at act 665, a request from the consumer to remove a product (e.g., by selecting the product from the consumer's list of relevant products). At act 665, the mobile device app may prompt the consumer to confirm. In response to the consumer's confirmation, the backend may, at act 675, delete an association between the consumer and the product. For instance, an entry corresponding to the consumer in a consumer database may be updated to delete a tag to the product identified by the product code. In some embodiments, an appropriate manufacturer may be notified of the deletion.

### VI. Combining Product Information and Consumer Information

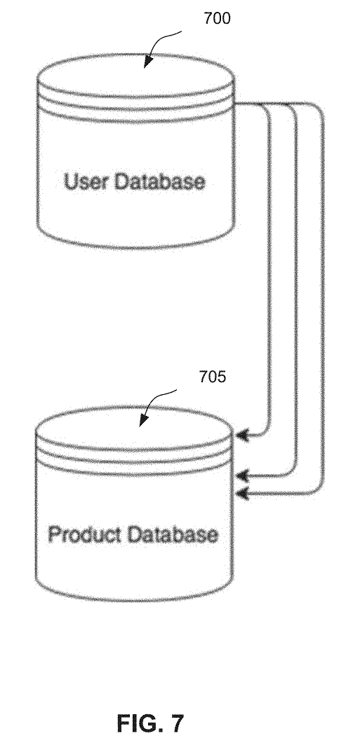

FIG. 7 shows an illustrative database 700 for storing personal information of consumers and an illustrative database 705 for storing product information, in accordance with some embodiments.

In some embodiments, a curated product information system may receive from a manufacturer information regarding a certain product and/or updates to such information. Upon receiving such information, the curated product information system may create and/or update an entry in the product database 705 corresponding to the product.

In some embodiments, a curated product information system may receive from a consumer a notification regarding an item newly acquired by the consumer. If the consumer has not previously used the curated product information system, the curated product information system may create an entry for the consumer in the database 700. For instance, as discussed above, the consumer may be identified using a token generated based on one or more pieces of personal information, such as email address and phone number. The curated product information system may determine whether the consumer has used the curated product information system previously by using the token to query the consumer database 705. If no match is returned, the curated product information system may create a new database entry associated with the token.

Furthermore, the curated product information system may query the product database 705 using one or more pieces of product information received from the consumer (e.g., UPC). If a match is returned, the curated product information system may link the database entry corresponding to the consumer to the database entry corresponding to the product.

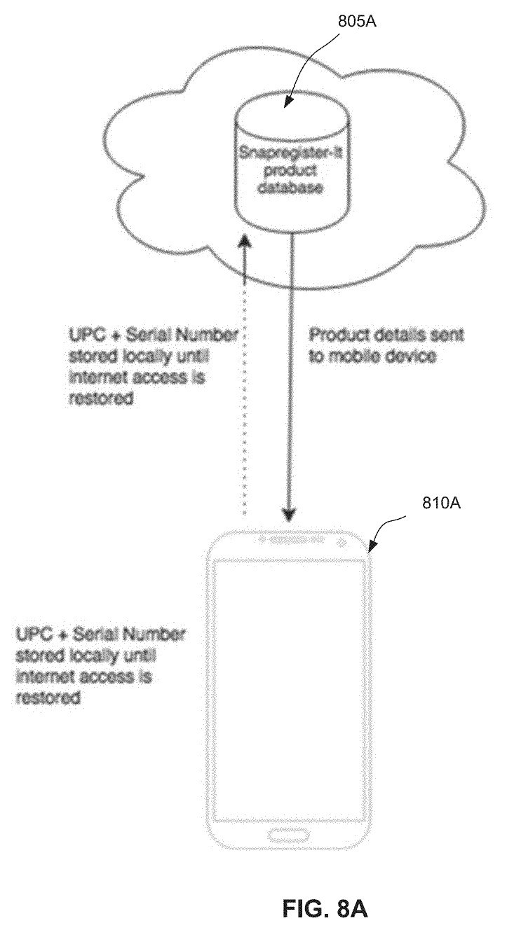

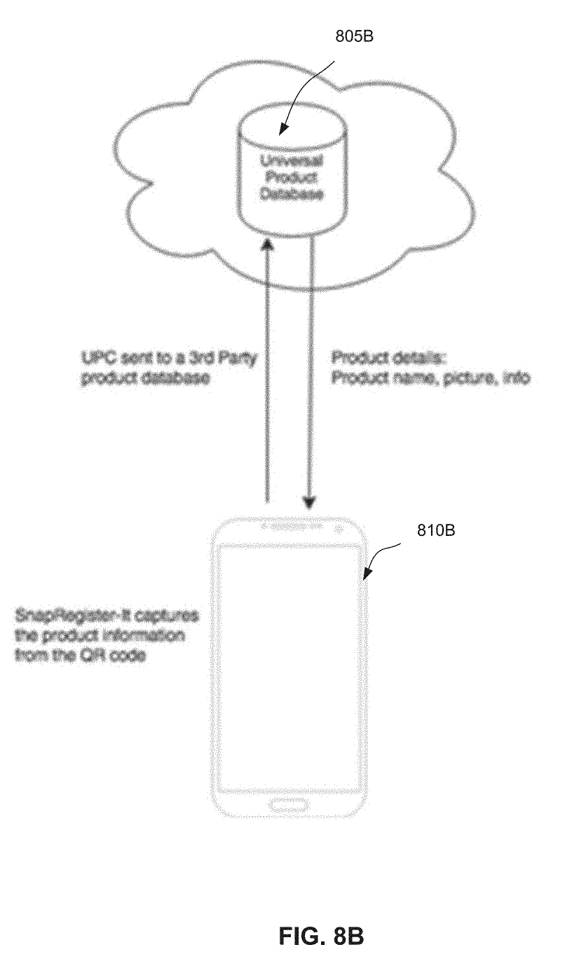

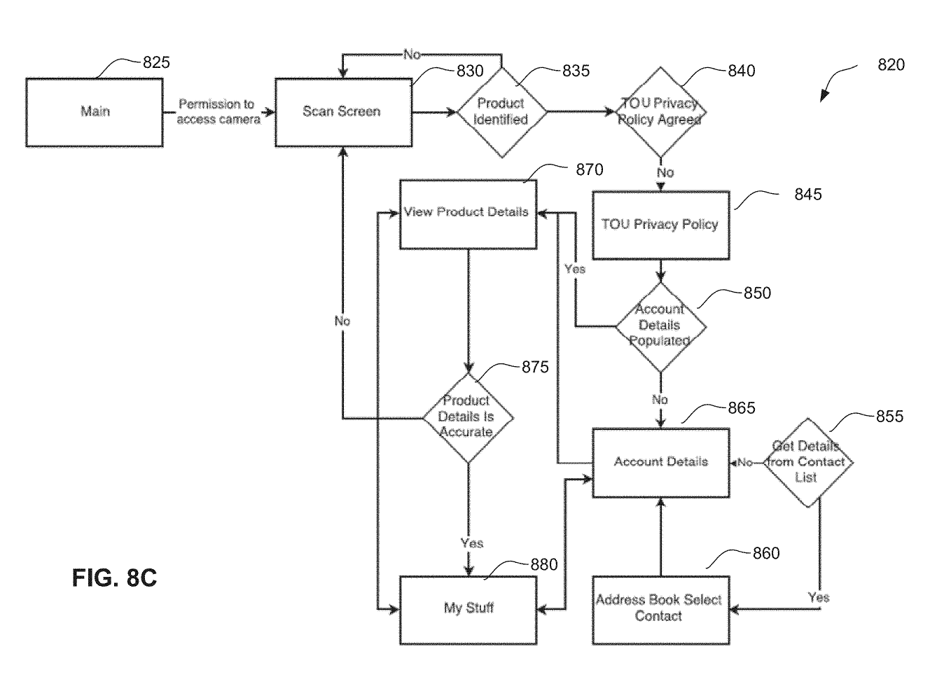

FIG. 8A shows an illustrative product database 805A and an illustrative mobile device 810A, in accordance with some embodiments. In this example, the product database 805A may reside in the cloud, and may be associated with a curated product information system. A mobile device app of the curated product information system may be installed on the mobile device 810A, and may be programmed to query the product database 805A via an Internet connection based on product information extracted from a scannable code or typed in by a consumer. If there is no Internet access, the mobile device app may withhold the query until Internet access is restored.

The inventors have recognized and appreciated that, by storing a product database in the cloud (as opposed to on a mobile device), an amount of local storage used by a mobile device app of a curated product information system may be reduced. However, that is not required, as in some embodiments a product database may be stored locally on a mobile device, so that a mobile device app of a curated product information system may query the product database even if the mobile device is not connected to the Internet. In such an embodiment, the product database may be updated when the mobile device is reconnected to the Internet. For instance, a consumer may specify that updates only occur when the mobile device is connected via Wi-Fi, to minimize consumption of the consumer's data plan.

FIG. 8B shows an illustrative product database 805B and an illustrative mobile device 810B, in accordance with some embodiments. In this example, the product database 805B may also reside in the cloud, but may be provided by a third party. A mobile device app of a curated product information system may be installed on the mobile device 810B, and may be programmed to query the third-party product database 805B via an Internet connection based on product information extracted from a scannable code or typed in by a consumer. If a matching product is found, the third-party product database 805B may send to the mobile device 810B detailed information such as product name, product image, date of manufacture, and other data for display to the consumer.

FIG. 8C shows an illustrative process 820 that may be performed by a mobile device app of a curated product information system to allow a consumer to indicate a product as being relevant, in accordance with some embodiments.

At act 825, the mobile device app may present a main screen to the consumer, such as the illustrative screen 200A shown in FIG. 2A. The main screen may prompt the consumer for permission to initiate a process to scan a scannable code. In response to receiving the consumer's permission, the mobile device app may, at act 830, present a scan screen, such as the illustrative screen 200B shown in FIG. 2B. The mobile device app may be programmed to automatically scan a scannable code and extract product information, for example, as discussed above in connection with FIGS. 2B-C. At act 835, the mobile device app may prompt the consumer to confirm that the extracted product information matches an item associated with the scannable code.

At act 840, the mobile device app may check if the consumer previously indicated agreement with the curated product information system's privacy and terms of use agreement. If not, the mobile device app may, at act 845, allow the consumer to review a privacy and terms of use agreement, for example, via the illustrative screen 200D shown in FIG. 2D. If the consumer previously indicated agreement with the privacy and terms of use agreement, the mobile device app may skip act 845.

At act 850, the mobile device app may check if the consumer previously provided personal details. If not, the mobile device app may, at act 855, ask the consumer for permission to retrieve personal details from the consumer's address book, for example, via the illustrative screen 200E shown in FIG. 2E. In response to receiving permission from the consumer, the mobile device app may, at act 860, ask the consumer to select an entry from the address book, for example, via the illustrative screen 200F shown in FIG. 2F. In some embodiments, the selection may be performed via a Contacts app on the consumer's mobile device, and the mobile device app of the curated product information system may receive the personal details via the Contacts app.

In response to the consumer's selection, the mobile device app may, at act 865, prompt the consumer to confirm the personal details retrieved from the address book, for example, via the illustrative screen 200G shown in FIG. 2G. If at act 855 the consumer does not give permission for the mobile device app to access the address book, the mobile device app may skip act 860, and prompt the consumer to manually enter personal details, for example, via the illustrative screen 200G shown in FIG. 2G.

If at act 850 the mobile device app determines that the consumer previously provided personal details, or if at 865 the consumer confirms accuracy of personal details, the mobile device app may, at act 870, present a product detail page, for example, as discussed above in connection with the illustrative screen 200H shown in FIG. 2H. In some embodiments, the mobile device app may, at act 875, prompt the consumer to confirm accuracy of displayed product details. In response to receiving the consumer's confirmation, the mobile device may, at act 880, present a list of products relevant to the consumer, for example, as discussed above in connection with the illustrative screen 400E shown in FIG. 4E. From this list, the consumer may select a product to view details relating to that product, and the mobile device app may return to act 870. If at act 875 the consumer indicates the product details are not accurate, the mobile device app may return to act 830 to re-scan the scannable code.

### VII. Backend Data Customization

The inventors have recognized and appreciated that a curated product information system may be used to help a manufacturer reach consumers who purchase the manufacturer's products. For instance, the manufacturer may wish to offer to consumers a variety of information, such as contact information (e.g., relevant phone numbers, email addresses, etc.), product documentation, setup videos, catalogs of replacement parts and/or accessories, and customer support web sites, etc. Accordingly, in some embodiments, a curated product information system may be programmed to provide access to such information to consumers. For instance, a curated product information system may be programmed to allow a manufacturer to submit one or more links to relevant information, and may provide such links to consumers.

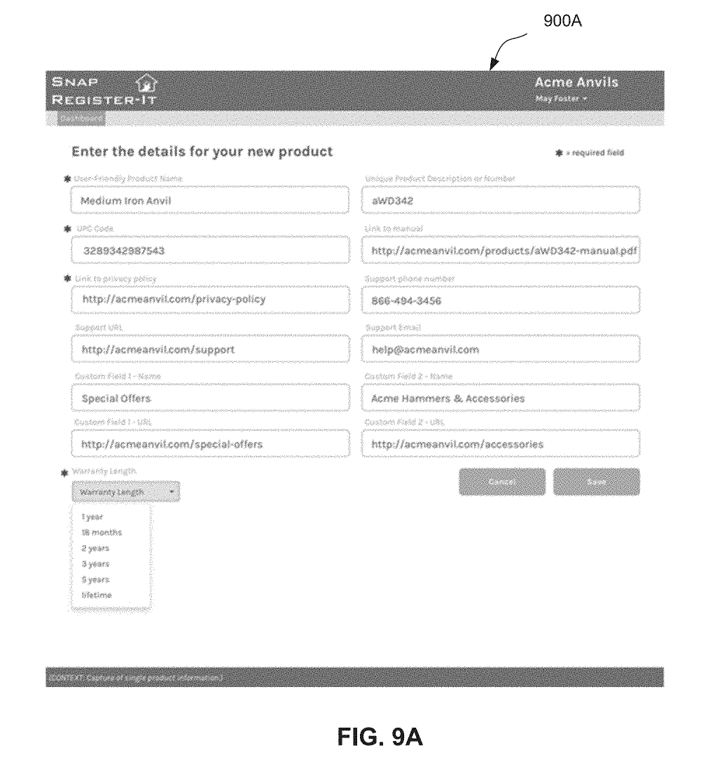

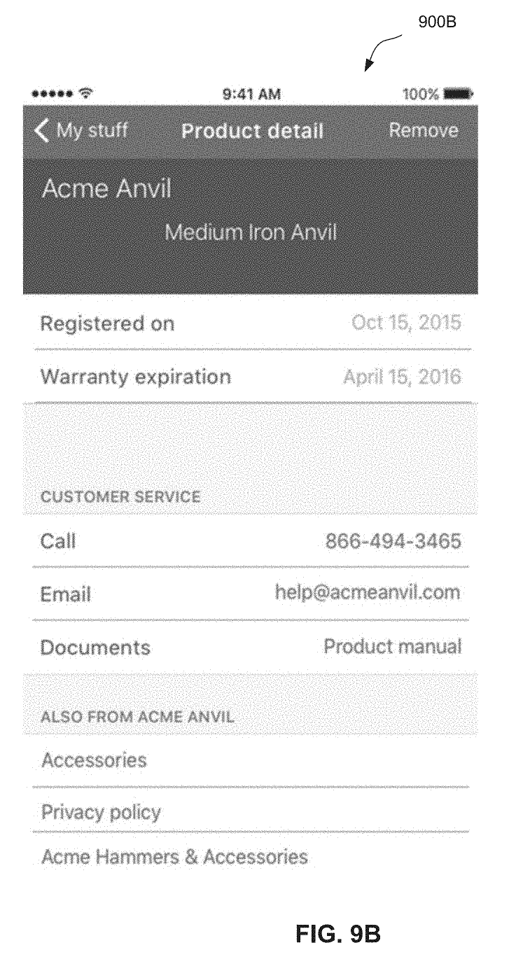

In some embodiments, a curated product information system may provide a web portal via which a manufacturer may enter detailed information for each product. FIG. 9A shows an illustrative form 900A that may be presented by a web portal of a curated product information system to an employee of a manufacturer to prompt the employee to enter relevant information for a product, in accordance with some embodiments. FIG. 9B shows an illustrative product detail page 900B that may be presented by a mobile device app of the curated product information system based on input provided by the employee of the manufacturer via the illustrative form 900A shown in FIG. 9A, in accordance with some embodiments. For instance, the page 900B may be generated by the curated product information system and transmitted to the mobile device app for presentation. Additionally, or alternatively, the curated product information system may transmit to the mobile device app information provided by the employee of the manufacturer via the illustrative form 900A, and the mobile device app may generate the page 900B accordingly.

In the example shown in FIG. 9A, the input form 900A includes one or more fields. In some embodiments, multiple fields may be present and may be arranged in pairs. For instance, each pair may include a first field for entering a text snippet to be displayed to consumers (e.g., “Special Offers,” “Acme Hammers & Accessories,” etc.), and a second field for entering information corresponding to the text in the first field, or a link to such information (e.g., http://acmeanvil.com/special-offers, http://acmeanvil.com/accessories, etc.). In this manner, the manufacturer may customize a product detail page presented to a consumer, such as the illustrative product detail page 900B shown in FIG. 9B.

It should be appreciated that aspects of the present disclosure are not limited to arranging fields in pairs on an input form. For instance, the example shown in FIG. 9A, there are several stand-alone fields, namely, user-friendly product name, unique product description or number, UPC, link to manual, link to privacy policy, support phone number, support URL (Uniform Resource Locator), and support email. Also, it should be appreciated that aspects of the present disclosure are not limited to the use of text input fields on an input form. For instance, the example shown in FIG. 9A, a drop-down menu is used for selecting a warranty length. Any suitable one or more input types (e.g., check boxes, radio buttons, sliders, etc.) may be used in addition to, or instead of, text input fields and/or drop-down menus.

In some embodiments, a curated product information system may allow a manufacturer to specify a scope to which a certain piece of information applies. As one example, certain information (e.g., customer support phone number, customer support email, privacy policy, etc.) may be applicable across all products associated with the manufacturer. If the manufacturer indicates a piece of information is applicable for all of the manufacturer's products, the curated product information system may display such information on a product detail page for every product associated with the manufacturer.

As another example, certain information (e.g., list of accessories, setup videos, list of service sites, etc.) may be applicable only to a specific product (or category of products). If the manufacturer indicates a piece of information is applicable only to a specific product (or category of products), the curated product information system may display such information on a product detail page for that product only (or products in that category only).

As another example, certain information may be applicable only to a certain set of items (e.g., as specified by a range of serial numbers and/or one or more attribute values such as time and/or state of purchase). If the manufacturer indicates a piece of information is applicable only to a certain set of items as specified using one or more criteria, the curated product information system may display such information on a product detail page only if a consumer has submitted product information matching the one or more criteria.

In some embodiments, a curated product information system may allow a manufacturer to upload multiple pieces of information (e.g., via pairs of input fields as described above), and to specify logic for determining which one or more pieces of information may be displayed to a consumer. As an example, if the consumer is located in France, the consumer may be presented with a service location in France, rather than a service location in the US, even if the consumer has a street address in the US. The curated product information system may be configured to access current location information from a mobile device of the consumer, for example, via a mobile device app of the curated product information system. As another example, if a mobile device of the consumer is configured to display in the Spanish language, the consumer may be presented with a link to a Spanish version of an owner's manual, even if the consumer is located in an English-speaking location. As another example, if an item is still under warranty, the consumer may be presented with a link to authorized repair facilities. Otherwise, the consumer may be presented with a link to obtain extended warranty.

The inventors have also recognized and appreciated that a manufacturer may wish to provide to its consumers a customized user experience. Accordingly, in some embodiments, a curated product information system may allow a manufacturer to specify a branded look-and-feel, and a mobile device app of the curated product information system may be programmed to present one or more pages with the branded look-and-feel to a consumer of a product made by the manufacturer.

In some embodiments, a web portal of the curated product information system may provide one or more templates for use by a manufacturer to upload customization information, such as links, link descriptions, images, logos, copy blocks, color choices, etc. Additionally, or alternatively, the web portal may provide a web form for entering customization information.

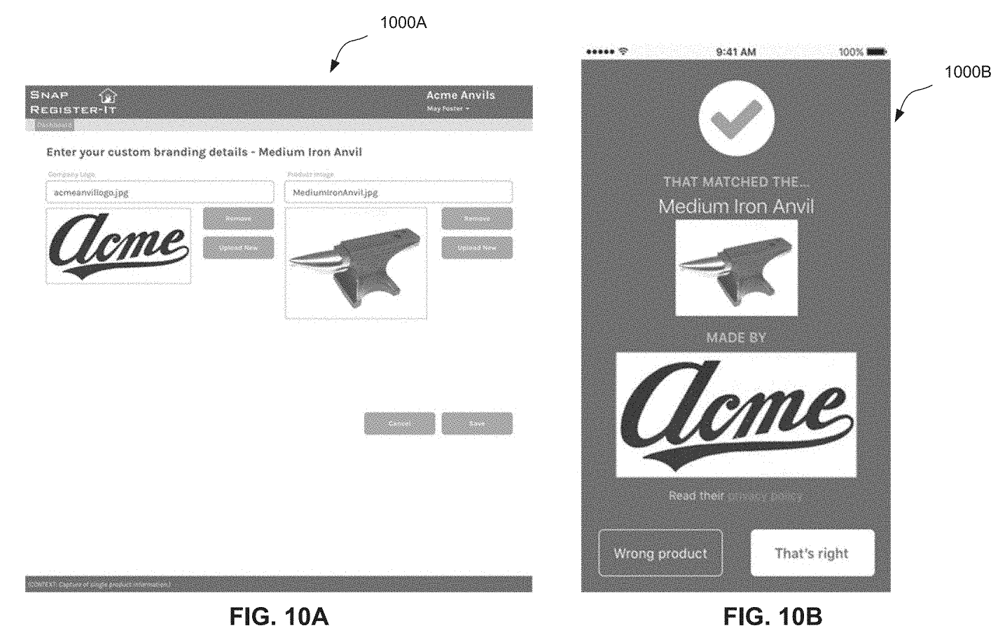

FIG. 10A shows an illustrative form 1000A that may be presented by a web portal of a curated product information system to an employee of a manufacturer to prompt the employee to enter customization information, in accordance with some embodiments. In this example, the form 1000A includes two image-upload fields, namely, “Company Logo” and “Product Image.” Any number of one or more image-upload fields, and/or any number of one or more other input elements (e.g., text input fields, radio buttons, check boxes, drop-down menus, sliders, etc.), may be used to prompt for customization information, as aspects of the present disclosure are not limited to the use of any particular input type.

FIG. 10B shows an illustrative confirmation page 1000B that may be generated by a mobile device app of the curated product information system based on input provided by the employee of the manufacturer via the illustrative form 1000A shown in FIG. 10A, in accordance with some embodiments. In this example, the confirmation page 1000B is presented to prompt a consumer to confirm that product information extracted from a scannable code matches a product the consumer wishes to indicate as being relevant. In some embodiments, the page 1000B may be generated by the curated product information system and transmitted to the mobile device app for presentation. Additionally, or alternatively, the curated product information system may transmit to the mobile device app customization information provided by the employee of the manufacturer via the illustrative form 1000A, and the mobile device app may generate the page 1000B accordingly.

### VIII. Bulk Upload

The inventors have recognized and appreciated that a manufacturer may wish to use services provided by a curated product information system for a broad portfolio of products. Accordingly, in some embodiments, a curated product information system may be programmed to allow a manufacturer to upload information for multiple products all at once.

In some embodiments, a web portal of a personal product system may be programmed to provide a link to download a bulk-upload template. For instance, the template may identify one or more data elements to be captured, such as user-friendly product name, unique product description or number, UPC, link to manual, link to privacy policy, support phone number, support URL, and support email, custom filed 1—name, custom filed 1—URL, custom filed 2—name, custom filed 2—URL, warranty length, etc.

In some embodiments, a bulk-upload template may provide formatting instructions, such as to enter US phone numbers formatted as xxx-xxx-xxxx, to enter a UPC as a 12-digit number and/or an EAN as a 13-digit number, etc.

In some embodiments, a bulk-upload template may additionally identify one or more pieces of customization information to be captured, such as links, link descriptions, images, logos, copy blocks, color choices, etc.

In some embodiments, a bulk-upload template may be provided in one file type for data entry (e.g., as a Microsoft Excel file), and may include instructions to generate a different file type for uploading (e.g., a tab-delimited text file).

In some embodiments, the web portal of the curated product information system may allow a manufacturer to select and upload a completed template. The web portal may perform data validation processing on an uploaded template, for example, by validating length, content, formatting, etc. of the uploaded data. If one or more error is identified, the web portal may present an error message, which may identify an error by type or by location within the template, or may indicate that a product entry in the template appear to be a duplicate of an entry already in a product database of the curated product information system.

In some embodiments, upon an error-free bulk upload, the web portal may display an acknowledgment, and the curated product information system may generate a plurality of product entries corresponding respectively to products contained in the uploaded template, and may store the product entries in a product database.

### IX. Data Export

The inventors have recognized and appreciated that a manufacturer may wish to receive information regarding identities and/or contact details of consumers who purchase the manufacturer's products, and/or information about which one or more products are purchased by each consumer. Accordingly, in some embodiments, a curated product information system may be programmed to allow a manufacturer to download information regarding consumers.

In some embodiments, to protect consumer privacy, a web portal of a curated product information system may allow a manufacturer to download information regarding a consumer only if the consumer has indicated at least one product made by the manufacturer as being relevant (e.g., by using a mobile device app of the curated product information system to scan a scannable code provided with at least one product). In some embodiments, a file available for download may include consumer identity and/or contact information, such as first name, last name, phone number, email address, street address line 1, street address line 2, city, state, zip code, etc. Additionally, or alternatively, the web portal may allow an employee of the manufacturer to view such information. However, in some embodiments, the web portal may allow the consumer to decide whether to make such information available for download, so that consumers may retain more control over their contact information.

In some embodiments, a file available for download by the manufacturer may include a record for each instance in which a product of the manufacturer is indicated by a consumer as being relevant. For instance, such a record may include data elements such as user-friendly product name, UPC, serial number, date on which the consumer indicated the product as being relevant, etc. Additionally, or alternatively, the web portal may allow an employee of the manufacturer to view such information.

In some embodiments, such record may include contact information for the consumer who indicated the product as being relevant. In this manner, the manufacturer may be able to reach the consumer if a safety issue arises with respect to the product. Additionally, or alternatively, the web portal may allow an employee of the manufacturer to view such information. However, in some embodiments, the web portal may allow the consumer to decide whether to make such information available for download, so that consumers may retain more control over their contact information.

In some embodiments, the web portal may allow the manufacturer to choose whether to download all records associated with the manufacturer's products, or only an incremental set of records since a last download. Additionally, or alternatively, the web portal may allow the manufacturer to download records for only a subset of the manufacturer's products (e.g., as specified by one or more product categories), and/or for only a certain set of items (e.g., as specified by a range of serial numbers and/or one or more attribute values such as time and/or state of purchase).

In some embodiments, a file available for download by the manufacturer may include product information previously provided by the manufacturer via the web portal, for example, as discussed above in connection with FIGS. 9A-B. Additionally, or alternatively, the web portal may allow an employee of the manufacturer to view such information.

In some embodiments, consumer information that is available to be downloaded as a file as described above may be transferred directly into a manufacturer's customer relationship management (CRM) software. This transfer may take place automatically (e.g., at a selected schedule), or may be manually initiated by an employee of the manufacturer. For instance, the curated product information system may provide an application programmable interface (API) to permit third-party software to export relevant customer details into the manufacturer's CRM software.

### X. Consumer Information Update

The inventors have recognized and appreciated that consumers may move to new addresses, and may change their names, email addresses, phone numbers, etc. To ensure timely delivery of important information to consumers (e.g., during a safety recall), a manufacturer may wish to maintain accuracy of consumer contact information. Accordingly, in some embodiments, a curated product information system may be programmed to notify a manufacturer of a change in relevant consumer contact information.

In some embodiments, a mobile device app of a curated product information system may be programmed to monitor updates made to contact information on a consumer's mobile device. Additionally, or alternatively, the mobile device app may provide an interface via which the consumer may update contact information.

In some embodiments, the mobile device app may transmit updated consumer contact information to a server of the curated product information system to be stored in a consumer database. Receipt of such an update may trigger an alert to the manufacturer. For instance, an alert may be displayed on a dashboard available to the manufacturer via a web portal of the curated product information system, and/or emailed to the manufacturer. Additionally, or alternatively, updated consumer contact information may be flagged in a data export pushed to, or pulled by, the manufacturer. Additionally, or alternatively, the curated product information system may be integrated with the manufacturer's customer relationship management (CRM) system, and may be programmed to cause consumer contact information in the CRM system to be updated appropriately.

In some embodiments, the curated product information system may, in response to a change in contact information for a consumer, notify all manufacturers for which the consumer has indicated at least one product as being relevant.

### XI. Consumer Notification

The inventors have recognize and appreciated that, for privacy reasons, some consumers may be reluctant to share contact information with manufacturers. For instance, a consumer may wish to manage unsolicited communications (e.g., via email, text, phone call, post, etc.). The inventors have also recognized and appreciated that some consumers would like easy access to communications that might interest them, provided such communications are non-intrusive (e.g., not interfering with normal use of email, text, phone, post, etc.).

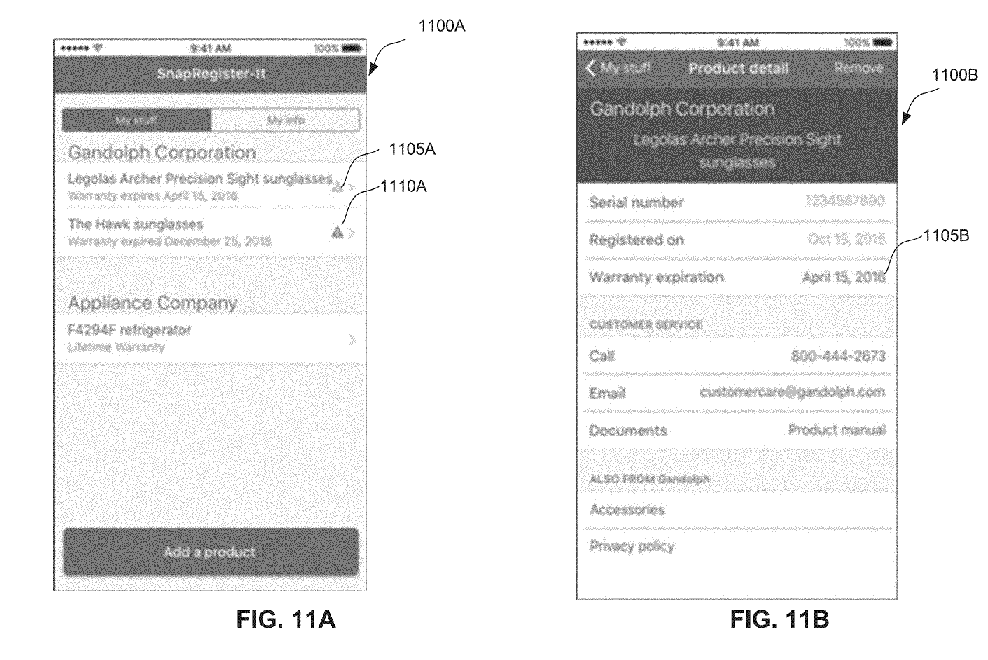

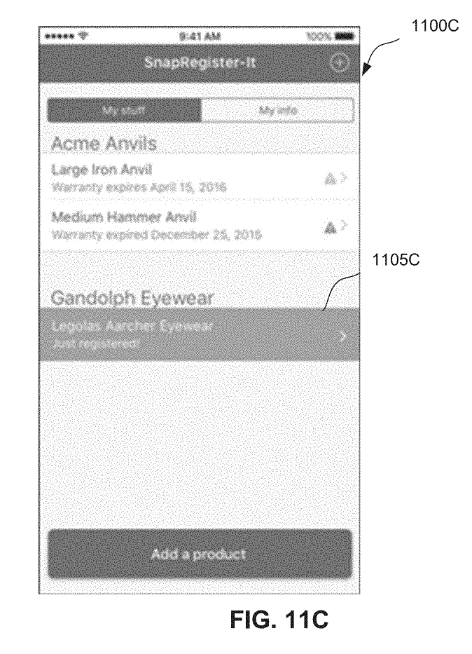

Accordingly, in some embodiments, a curated product information system may be programmed to deliver a manufacturer alert to a consumer in a non-intrusive manner. For instance, the curated product information system may deliver a manufacturer alert via a mobile device app running on the consumer's mobile device. FIGS. 11A-C shows illustrative consumer notification methods, in accordance with some embodiments.

In some embodiments, the mobile device app of the curated product information system may be programmed to alert a consumer to a communication by altering an appearance of a product in a personal product list. For instance, in the example shown in FIG. 11A, a pending warranty expiration is indicated using a yellow caution sign at 1105A, and an expired warranty is indicated using a red caution sign at 1110A. In this manner, the consumer may be notified of a communication from a manufacturer without excessive interference with the consumer's communications via email, text, phone, post, etc. In the example shown in FIG. 11C, a successful registration of a product is indicated by highlighting a corresponding product row in the product list in green at 1105C.

In some embodiments, the mobile device app of the curated product information system may be programmed to alert a consumer to a communication by altering an appearance of a data element shown in a product detail page. For instance, in the example shown in FIG. 11B, an expired warranty expiration is indicated by displaying an expiration date in red.

Thus, a way in which an appearance is altered may depend on certain information to be conveyed. For instance, in the example shown in FIG. 11B, an altered appearance for a warranty might signify whether the warranty is about to expire. In the example shown in FIG. 11B, an altered product row appearance (such as by color and/or symbol) may signify availability of relevant information (e.g., new communication from a corresponding manufacturer regarding that product). In some embodiments, an altered manufacturer row appearance may signify availability of relevant information regarding the manufacturer.

In some embodiments, an altered appearance may follow a certain scheme, for example, based on a type of information to be conveyed. For example, safety information may be indicated using a red font or symbol, an alert (e.g., an expiring warranty) may be indicated using a yellow font or symbol, a capability or option for a product may be indicated using a blue font or symbol, etc.

In some embodiments, availability of one or more alerts in the mobile device app of the curated product information system may be conveyed to a consumer via a small indicator on an app tile. Such an indicator may be provided via an operating system of the consumer's mobile device. The mobile device app of the curated product information system may be programmed to cause, via the operating system, a number of availability alerts to be shown with the indicator. Once the consumer brings the mobile device app of the curated product information system to the foreground and reads one or more available alerts, the mobile device app of the curated product information system may cause, via the operating system, an update of the app tile indicator. For instance, the number of availability alerts may be reduced based on a number of alerts read by the consumer, or the app tile indicator may disappear if there is no unread alert.

In some embodiments, the curated product information system may be programmed to send safety alerts to the consumer via a channel that is independent of the mobile device app of the curated product information system. For instance, the curated product information system may send safety alerts via text, email, phone, post, etc., as selected by the consumer.

### XII. Illustrative Devices

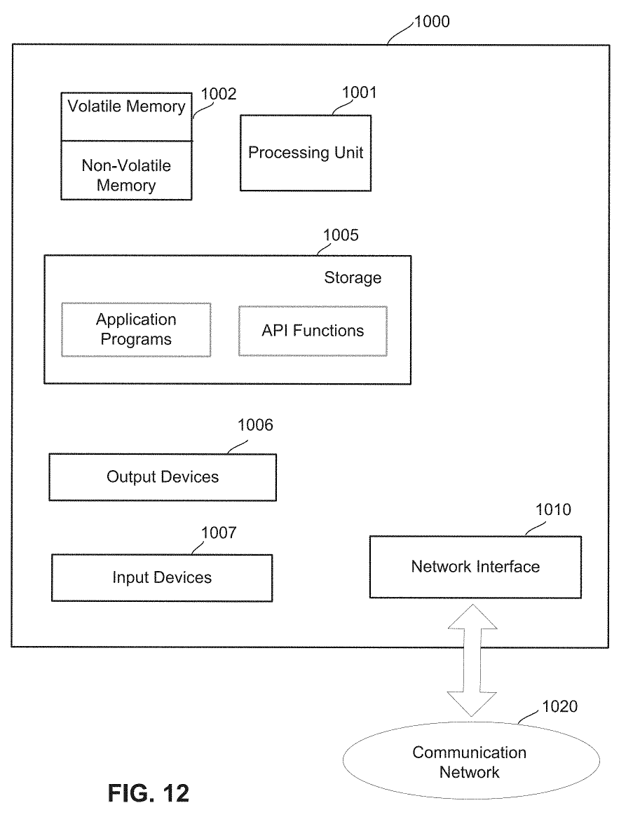

FIG. 12 shows, schematically, an illustrative computer 1000 on which any aspect of the present disclosure may be implemented.

In the embodiment shown in FIG. 12, the computer 1000 includes a processing unit 1001 having one or more processors and a non-transitory computer-readable storage medium 1002 that may include, for example, volatile and/or non-volatile memory. The memory 1002 may store one or more instructions to program the processing unit 1001 to perform any of the functions described herein. The computer 1000 may also include other types of non-transitory computer-readable medium, such as storage 1005 (e.g., one or more disk drives) in addition to the system memory 1002. The storage 1005 may also store one or more application programs and/or resources used by application programs (e.g., software libraries), which may be loaded into the memory 1002.

The computer 1000 may have one or more input devices and/or output devices, such as devices 1006 and 1007 illustrated in FIG. 12. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 12, the computer 1000 may also comprise one or more network interfaces (e.g., the network interface 1010) to enable communication via various networks (e.g., the network 1020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A system for providing access to information related to a product, the system comprising:
at least one hardware sensor;
at least one processor; and
at least one computer-readable storage medium having encoded thereon instructions which, when executed by the at least one processor, program the at least one processor to:
in response to a first input from a user, cause the at least one hardware sensor to scan a code associated with an item of the product;
process data from the at least one hardware sensor to extract an identifier for the product;
use the identifier for the product to retrieve information relating to the product; and
display the retrieved information to the user.

2. The system of claim 1, wherein the retrieved information relates to at least one topic selected from a group consisting of: replacement parts, owner's manual, how-to videos, customer service, accessories, supplies, and warranty.

3. The system of claim 1, wherein:
the code comprises an optical code;
the at least one hardware sensor comprises an optical sensor; and
the data output by the at least one hardware sensor comprises an image of the optical code.

4. The system of claim 3, further comprising an object on which the code is printed, wherein the object is selected from a group consisting of: a package of the item of the product, a label affixed to the item of the product, and an insert placed with the product.

5. The system of claim 1, wherein:
the code is stored in a radio frequency identification (RFID) tag; and
the at least one hardware sensor comprises an RFID reader.

6. The system of claim 1, wherein the at least one processor is programmed by the instructions to process data from the at least one hardware sensor at least in part by:
converting the data from the at least one hardware sensor to textual data; and
parsing at least a portion of the textual data to extract one or more data elements, the one or more data elements comprising the identifier for the product.

7. The system of claim 1, wherein the at least one processor is programmed by the instructions to retrieve the information relating to the product at least in part by:
using the identifier for the product to query a product database; and
access the information relating to the product from an entry corresponding to the product in the product database.

8. The system of claim 7, wherein the at least one processor is programmed by the instructions to query the product database via at least one network connection.

9. The system of claim 7, wherein the at least one processor is further programmed by the instructions to:
cause an entry corresponding to the user in a user database to be linked to the entry corresponding to the product in the product database.

10. The system of claim 7, wherein the identifier for the product includes a standardized product identifier.

11. The system of claim 10, wherein the standardized product identifier comprises a UPC or an EAN.

12. The system of claim 1, wherein the at least one processor is further programmed by the instructions to process the data from the at least one hardware sensor to extract an identifier for the item of the product.

13. The system of claim 12, wherein the an identifier for the item of the product comprises a serial number.

14. The system of claim 1, wherein the retrieved information comprises at least one link to a web page relating to the at least one topic selected from the group consisting of: replacement parts, owner's manual, customer service, accessories, supplies, and warranty.

15. The system of claim 14, wherein the at least one processor is further programmed by the instructions to:
receiving a second input from the user indicating the user wishes to access the at least one link; and
causing the user to be navigated to the web page.

16. A method for providing access to information related to a product, the method comprising acts of:
in response to a first input from a user, causing the at least one hardware sensor to scan a code associated with an item of the product;
processing data from the at least one hardware sensor to extract an identifier for the product;
using the identifier for the product to retrieve information relating to the product; and
displaying the retrieved information to the user.

17. At least one computer-readable storage medium having encoded thereon instructions which, when executed by at least one processor, program the at least one processor to:
in response to a first input from a user, cause at least one hardware sensor to scan a code associated with an item of the product;
process data from the at least one hardware sensor to extract an identifier for the product;
use the identifier for the product to retrieve information relating to the product; and
displaying the retrieved information to the user.
